(19) United States
(12) Patent Application Publication
(10) Pub. No.: US 2004/0122125 A1
(43) Pub. Date: Jun. 24, 2004

(54) Lactone compounds as novel photoinitiators

(76) Inventors: Lajos Avar, Biel-Benken (CH); Rene Bar, Basel (CH); Victor Sanahuja, Barcelona (ES)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/467,560

(22) PCT Filed: Feb. 14, 2002
(86) PCT No.: PCT/IB02/00470

(30) Foreign Application Priority Data
Feb. 15, 2001 (CH) 0261-01

(51) Int. Cl. C08J 3/28

(52) U.S. Cl. 522/168

(57) ABSTRACT

The invention relates to the novel use of known lactone compounds of the formula (I)

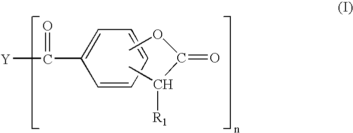

in which n, Y and R₁ are as defined in Patent claim 1,

as photoinitiators for systems which can be polymerized by means of UV light, and to a process for the photopolymerization of unsaturated compounds using lactone compounds of the formula (I). The invention furthermore relates to compounds of the formula (I) in which R₁ is an unsubstituted phenyl radical.

The invention relates to a photopolymerization process which is characterized by the use of lactone compounds of the formula (I) below, and to the use of these lactone compounds as photoinitiators for systems which can be polymerized by means of UV light.

The object of the invention was to provide novel photoinitiators for polymerizable unsaturated compounds.

This object is achieved by lactones of the formula (I) below, some of which are already known. Surprisingly, it has been found that these compounds are highly effective photoinitiators for unsaturated compounds which can be polymerized by means of UV light.

WO 80/01566 discloses Benzofuran-2-on compounds as stabilizers for polymers; WO 00/41990 discloses the use of Benzophenones as photoinitiators.

The invention thus relates to a photopolymerization process comprising the following steps:

a) incorporation of at least one lactone compound of the formula (I) into the system to be polymerized in an amount adequate for polymerization, giving a photo-polymerizable composition;

b) initiation and performance of the photopolymerization by irradiation of the photo-polymerizable composition with UV light for a time duration which is necessary for the polymerization.

Suitable lactone compounds of the formula (I) are

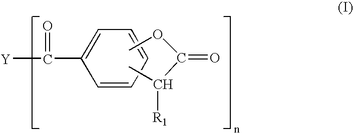

in which

n is 1 or 2;

R₁ is hydrogen, a linear or branched C₁₋₈ alkyl radical, a linear or branched C₁₋₁₂ alkoxy radical or an unsubstituted phenyl radical;

Y for n=1 is a linear or branched C₁₋₁₂ alkyl radical which is unsubstituted or interrupted by 0, or a 5- to 6-membered heteroaromatic radical which contains sulphur, nitrogen and/or oxygen as heteroatom and which is unsubstituted or substituted by halogen or alkyl, or is a radical of the formulae (i) to (v)

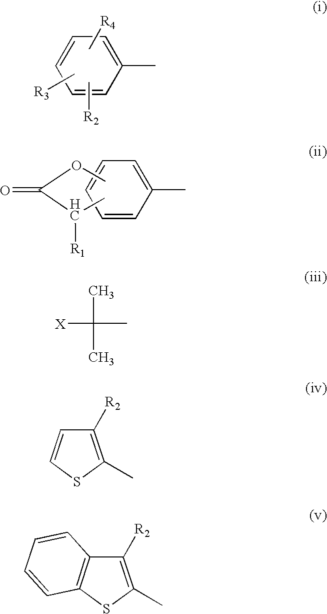

R₂, R₃ and R₄, independently of one another, are hydrogen, a linear or branched C₁₋₄ alkyl radical, a linear or branched C₁₋₁₂ alkoxy radical, a thioalkyl radical or a halogen atom;

X is a hydroxyl radical, a halogen atom or a radical of the formula (vi) or (vii)

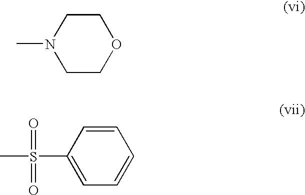

Y for n=2 is a divalent aromatic bridging unit from the group consisting of phenylene, diphenylene, diphenyl ether and diphenyl sulphide.

Sub-steps (a) and (b) are carried out by generally conventional processes. Thus, the addition of the photoinitiator to the photopolymerizable systems usually takes place by simple stirring-in, since most of these systems are liquid or readily soluble. In most cases, the initiator dissolves, which ensures uniform distribution therein and transparency of the polymers.

The polymerization is carried out by known photopolymerization methods by irradiation with light which is rich in short-wave radiation. Suitable light sources are, for example, medium-pressure, high-pressure and low-pressure mercury lamps, and superactinic fluorescent tubes whose emission maxima are in the range between 250 and 400 nm.

Y is preferably an unsubstituted or substituted phenyl radical, thienyl or benzothienyl.

R₁ is preferably hydrogen, a linear or branched C₁₋₄ alkyl radical or a linear or branched C₁₋₄ alkoxy radical, or is a phenyl radical, particularly preferably a phenyl radical.

Halogen is preferably chlorine.

Some of the lactones of the formula (I) are known compounds which can be prepared by processes that have been described, for example by reaction of a compound of the formula (II)

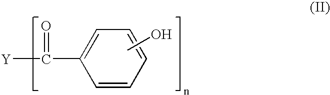

with an acid of the formula (III)

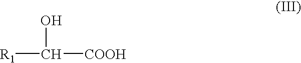

where the symbols n, Y and R₁ are as defined above.

The compounds of the formula (I) in which R₁ is an unsubstituted phenyl radical are novel and are prepared by reaction of a compound of the formula (II) with mandelic acid.

The lactone compounds of the formula (I) are advantageously employed in amounts of from 0.1 to 8% by weight, preferably from 1 to 7% by weight, particularly preferably from 2 to 6% by weight, based on the system to be polymerized. The respective amount is dependent firstly on the nature of the unsaturated compound to be polymerized and secondly on the particular area of application.

The term system here is taken to mean the mixture of the photopolymerizable or cross-linkable compound and the lactone compound and the other fillers and additives, as is necessary for the particular application.

The invention furthermore relates to the use of the lactones of the formula (I) as photoinitiators for unsaturated compounds which can be polymerized by means of UV light.

Compounds of this type are, for example, unsaturated monomers, such as esters of acrylic or methacrylic acid, for example methyl, ethyl, n- or tert-butyl, isooctyl or hydroxyethyl acrylate, methyl or ethyl methacrylate, ethylene diacrylate, neopentyl diacrylate, trimethylolpropane trisacrylate, pentaerythritol tetraacrylate or pentaerythritol trisacrylate; acrylonitrile, methacrylonitrile, acrylamide, methacrylamide, N-substituted (meth)acrylamides; vinyl esters, such as, for example, vinyl acetate, propionate, acrylate or succinate; other vinyl compounds, such as vinyl ethers, styrene, alkylstyrenes, halostyrenes, divinylbenzene, vinylnaphthalene, N-vinylpyrrolidone, vinyl chloride or vinylidene chloride; allyl compounds, such as diallyl phthalate, diallyl maleate, triallyl isocyanurate, triallyl phosphate or ethylene glycol diallyl ether, and mixtures of unsaturated monomers of this type.

Photopolymerizable compounds are furthermore unsaturated oligomers or polymers and mixtures thereof with unsaturated monomers. These include thermoplastic resins containing unsaturated groups, such as fumarates, allyl groups or acrylate or methacrylate groups. These unsaturated groups are in most cases bonded to the main chain of these linear polymers via functional groups. Mixtures of oligomers with mono- and polyunsaturated monomers are of great importance. Examples of oligomers of this type are unsaturated polyesters, unsaturated acrylic resins and isocyanate- or epoxy-modified acrylate oligomers, and also polyether acrylate oligomers. Examples of polyunsaturated compounds are, in particular, the acrylates of diols and polyols, for example hexamethylene diacrylate or pentaerythritol tetraacrylate. Preferred mono-unsaturated monomers are acrylates, such as, for example, butyl acrylate, phenyl acrylate, benzyl acrylate, 2-ethylhexyl acrylate or 2-hydroxypropyl acrylate. By selecting from the various representatives of the three components, it is possible to vary the consistency of the unpolymerized mixture and the plasticity of the polymerized resin.

Besides these three-component mixtures, a major role in these polyester resins is played by, in particular, two-component mixtures. These usually consist of an unsaturated polyester and a vinyl compound. The unsaturated polyesters are oligomeric products of the esterification of at least one unsaturated dicarboxylic acid, such as, for example, maleic, fumaric or citraconic acid, and at least unsaturated dicarboxylic acid, such as, for example, phthalic acid, succinic acid, sebacic acid or isophthalic acid, with glycols, such as, for example, ethylene glycol, propane-1,2-diol, di- or triethylene glycol or tetramethylene glycol, with monocarboxylic acids and monoalcohols usually also being used concomitantly for the modification. These unsaturated polyesters are usually dissolved in a vinyl or allyl compound, with styrene preferably being used for this purpose.

Photopolymerizable systems as used for the various purposes will comprise a number of other additives in addition to the photopolymerizable compounds and the photoinitiator. Thus, it is frequently usual to add thermal inhibitors, which are intended to provide protection against premature polymerization, in particular during preparation of the systems by mixing of the components.

In order to increase the dark-storage stability, copper compounds, such as copper naphthenate, stearate or octanoate, phosphorus compounds, such as triphenylphosphine, tributylphosphine, triethyl phosphite, triphenyl phosphite or tribenzyl phosphate, quaternary ammonium compounds, such as tetramethylammonium chloride or trimethylbenzylammonium chloride, or hydroxylamine derivatives, such as, for example, N-diethylhydroxylamine, can be added.

Photopolymerizable systems furthermore comprise—depending on the application —fillers, such as silicic acid, talc or gypsum, pigments, dyes, fibres, thixotropic agents or flow assistants.

Furthermore, it is also possible to use combinations with known photoinitiators, such as benzoin ethers, dialkoxyacetophenones or benzil ketals.

Particularly for the photopolymerization of thin layers and printing inks, combinations of the photoinitiator according to the invention with amines and/or aromatic ketones can be used. Examples of amines are triethylamine, N-methyldiethanolamine, N-dimethylethanolamine or p-dimethylaminobenzoic acid esters. Examples of ketones are benzophenone, substituted benzophenone derivatives, Michler's ketone, anthraquinone and anthraquinone derivatives, and thioxanthone and derivatives thereof.

Photocuring is of great importance for printing inks since the drying time of the binder is a crucial factor for the production speed of graphic products and should be in the order of fractions of seconds. The initiator according to the invention is also highly suitable for photocurable systems for the production of printing plates. Here, use is made, for example, of mixtures of soluble linear polyamides with photopolymerizable monomers, for example acrylamides, and a photoinitiator. Films or plates made from these systems are exposed via the negative (or positive) of the print master, and the uncured areas are subsequently removed using a solvent.

A further area of application of UV curing is metal coating, for example in the coating of metal sheets for tubes, cans or bottle tops, and the UV curing of plastic coatings, for example of PVC-based floorcoverings and wallcoverings.

Examples of the UV curing of paper coatings are the colourless lacquering of labels, record sleeves or book covers.

The invention is explained by the following examples.

### PREPARATION EXAMPLE 1

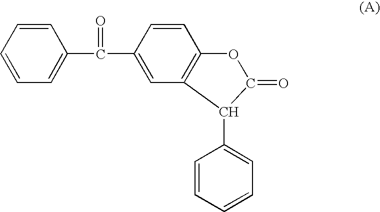

41.4 g of 4-hydroxybenzophenone and 33.5 g of mandelic acid are introduced into a 4-necked flask fitted with thermometer, stirrer and water separator, and the mixture is stirred at 185° C. for 20 hours, during which 4.7 g of H₂O are eliminated. The dark-brown reaction composition formed is crystallized from a solution consisting of 130 ml of methanol and 30 ml of toluene. The precipitate is filtered off with suction and recrystallized a number of times from isopropanol/toluene, giving a white product of the formula (A) having a melting point of 129.5-130.5° C.

### PREPARATION EXAMPLES 2-10

The following compounds of the formula (B) are prepared analogously to the preparation of the compound of the formula (A):

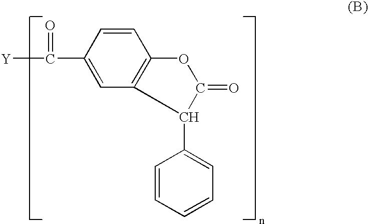

TABLE 1

| Example | Y | n |
|---|---|---|
| 2 | 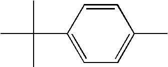 | 1 |
| 3 | 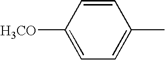 | 1 |
| 4 | 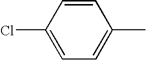 | 1 |
| 5 | H₃C— | 1 |
| 6 | 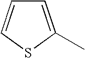 | 1 |
| 7 | 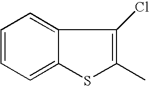 | 1 |
| 8 | 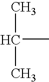 | 1 |
| 9 | 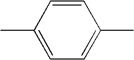 | 2 |
| 10 | 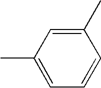 | 2 |

### APPLICATION EXAMPLE 1

A mixture consisting of 60 g of a prepolymer of the formula:

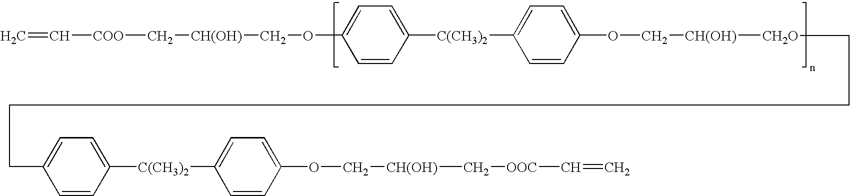

having a viscosity of about 9000 poise (at 77° C.), 35 g of pentaerythritol tetraacrylate and 5 g of the compound from Example 1 are applied to coated art paper in an amount of 3.5 g/m² using a spatula and cured in a UV Mini-Cure apparatus at a belt speed of 72 m/minute to give a glossy film.

### APPLICATION EXAMPLE 2

3 parts of a photoinitiator from Table 1 are mixed with 100 parts of an amine-modified polyether acrylate (viscosity at 23° C.: 600 mpas)—Laromer® PO 84F (BASF AG).

The curing rate is tested as the belt speed with which a liquid lacquer film applied to white paper can be passed under an undoped mercury high-pressure lamp (power: 120 W/cm of lamp length; lamp separation from the substrate 12 cm) in order to obtain an adherent coating which resists scratching with the fingernail. The liquid lacquer films are applied using a 100 μm wire-wound coating rod.

### APPLICATION EXAMPLE 3

3 parts of a photoinitiator selected from Table 1 are mixed with a mixture of 90 parts of an amine-modified polyacrylate (viscosity at 23° C.: 600 mpas)—Laromer® PO 84F (BASF AG)—and 10 parts of anatase. The layer thickness that can be cured through is determined. To this end, the lacquer introduced into a vessel with a depth of about 1 cm is irradiated at a belt speed of 5 m/min. The cured layer is washed off with ethyl acetate and its thickness determined.

1. Photopolymerization process, comprising the following steps:
a) incorporation of at least one lactone compound of the formula (I) into the system to be polymerized in an amount adequate for polymerization, giving a photopolymerizable composition;
b) initiation and performance of the photopolymerization by irradiation of the photopolymerizable composition with UV light for a time duration which is necessary for the polymerization, 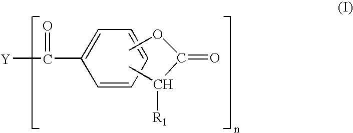
in which
n is 1 or 2;
R₁ is hydrogen, a linear or branched C₁₋₈ alkyl radical, a linear or branched C₁₋₁₂ alkoxy radical or an unsubstituted phenyl radical;
Y for n=1 is a linear or branched C₁₋₁₂ alkyl radical which is unsubstituted or interrupted by O, or a 5- to 6-membered heteroaromatic radical which contains sulphur, nitrogen and/or oxygen as heteroatom and which is unsubstituted or substituted by halogen or alkyl, or is a radical of the formulae (i) to (v) 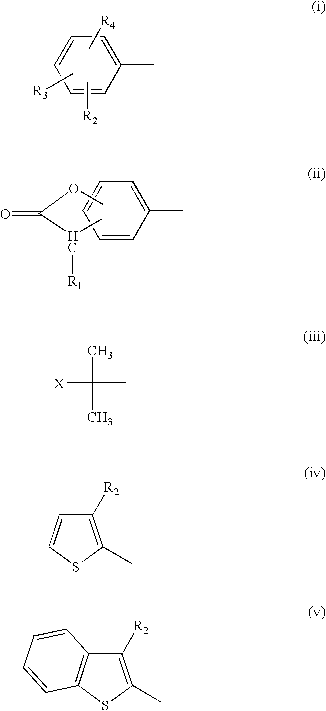
R₂, R₃ and R₄, independently of one another, are hydrogen, a linear or branched C₁₋₄ alkyl radical, a linear or branched C₁₋₁₂ alkoxy radical, a thioalkyl radical or a halogen atom;
X is a hydroxyl radical, a halogen atom or a radical of the formula (vi) or (vii) 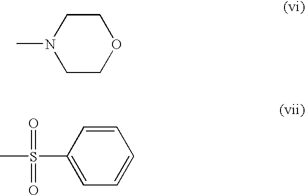
Y for n=2 is a divalent aromatic bridging unit from the group consisting of phenylene, diphenylene, diphenyl ether and diphenyl sulphide.

2. Process according to Patent claim 1, characterized in that lactone compounds in which Y is phenyl, substituted phenyl, thienyl or benzothienyl are employed.

3. Process according to Patent claim 1 or 2, characterized in that compounds in which R₁ is hydrogen, a linear or branched C₁₋₄ alkyl radical or a linear or branched C₁₋₄ alkoxy radical or a phenyl radical are employed.

4. Process according to one of Patent claims 1 to 4, characterized in that a lactone compound of the formula (I) according to Patent claim 1 is employed in amounts of from 0.1 to 8% by weight, preferably from 1 to 7% by weight, particularly preferably from 2 to 6% by weight, based on the system to be polymerized.

5. Use of compounds of the formula (I) according to Patent claim 1 as photoinitiators for unsaturated compounds which can be polymerized by means of UV light.

6. Compounds of the formula (I) according to Patent claim 1, in which R₁ is an unsubstituted phenyl radical.

7. Process for the preparation of compounds according to Patent claim 6, characterized in that compounds of the formula (II) 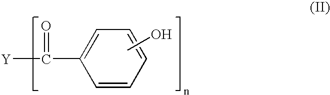
in which n and Y are as defined in claim 1,
are reacted with mandelic acid.
